(19) United States
(12) Patent Application Publication
(10) Pub. No.: US 2009/0044915 A1
(43) Pub. Date: Feb. 19, 2009

(54) Sheet bonding machine, image forming apparatus including same, and sheet bonding method

(75) Inventors: Takehide Mizutani, Sagamihara-shi (JP); Kazuhisa Sudo, Kawasaki-shi (JP); Mikio Ishibashi, Yokohama-shi (JP); Reki Nakamura, Sagamihara-shi (JP); Megumi Arai, Yokohama-shi (JP); Yukiko Iwasaki, Yokohama-shi (JP); Kazuhiko Yuki, Kawasaki-shi (JP); Nobuyuki Koinuma, Yokohama-shi (JP); Ryuji Yoshida, Yokohama-shi (JP); Kohsuke Yamamoto, Numazu-shi (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/222,770

(22) Filed: Aug. 15, 2008

(30) Foreign Application Priority Data
Aug. 16, 2007 (JP) 2007-212041
Jun. 2, 2008 (JP) 2008-144036

(51) Int. Cl. B65C 11/02; B32B 37/14

(52) U.S. Cl. 156/384; 156/494

(57) ABSTRACT

A sheet bonding machine bonds together a first sheet and a second sheet including an adhesion layer formed on one side thereof, covered with a release paper, includes a transport unit to transport the first sheet unidirectionally, a feeder to feed the second sheet obliquely toward the first sheet, a separation unit, a reel, an adhesion point, and a tensioner. The release paper is removed from the second sheet by the separation unit located upstream from the contact portion, and reeled by the reel. The second sheet adheres to the first sheet via the adhesion layer 91b at the adhesion point located downstream from the separation unit. The tensioner is located upstream from the separation unit and keeps the second sheet taut.

### CROSS-REFERENCE TO RELATED APPLICATIONS

This patent specification claims priority to Japanese Patent Application Nos. 2007-212041, filed on Aug. 16, 2007 and 2008-144036, filed on Jun. 2, 2008 in the Japan Patent Office, the entire contents of each of which are hereby incorporated by reference herein.

### BACKGROUND OF THE INVENTION

1. Field of the Invention

The present invention generally relates to a sheet bonding machine, an image forming apparatus including the sheet bonding machine, and a sheet bonding method.

2. Discussion of the Background Art

Various sheets can be formed by bonding two sheets together. For example, an image record sheet as glossy as a photograph can be readily produced by forming an image on a transparent sheet through an electrographic image forming method and bonding the transparent sheet and a white sheet together with the image sandwiched therebetween.

In a known sheet bonding method, adhesive is sprayed on an image surface of the transparent sheet, and then the transparent sheet is bonded to the white sheet.

However, when two sheets are bonded together as described above, air bubbles are likely to be included therebetween. In the image record sheet, even minute air bubbles diffuse reflection of light, giving the image record sheet turbid whiteness that degrades image quality.

When two sheets are bonded together in practical operations either manually or mechanically, air bubbles tend to be included therebetween for a variety of reasons, including unevenness of a surface of an adhesion layer formed of one of the sheet, misalignment of the sheets, improper bonding angle, etc.

In a known sheet bonding method, the adhesive layer is preliminarily formed on one of those sheets and is covered with a release paper to simplify a bonding process. Then, the sheet covered with the release paper is rolled. The sheet bonding device supports it with a support shaft and reels the release paper with a reel shaft to remove it from the adhesive layer just before the bonding process. After two sheets are bonded together tentatively, a pair of pressure rollers unites them with pressure.

When the reel shaft that removes the release paper from the sheet stops, the rolled sheet supported by the support shaft can rotate due to inertial force (inertia), which slackens the sheet upstream from a position where the release paper is removed therefrom.

When the sheet slacks upstream from the position where the release paper is removed, an angle at which the release paper leaves the sheet, which is hereinafter referred to as a separation angle, fluctuates, which is undesirable because, when the separation angle fluctuates, the sheet can deviates from a bonding position, resulting in bonding failure. If the slack sheet is bonded to the other sheet, the sheet wrinkles and/or air bubbles are included between two sheets when the pressure rollers unit them. Further, when the sheet slacks to different extents in a front portion and a back portion of the sheet bonding device, the sheet can curl obliquely.

### SUMMARY OF THE INVENTION

In view of the foregoing, various illustrative embodiment of the present invention disclosed herein can provide bonded sheets with enhanced quality.

In an illustrative embodiment of the present invention, a sheet bonding machine bonds together a first sheet and a second sheet including an adhesion layer formed on one side thereof, covered with a release paper. The sheet bonding machine includes a transport unit configured to transport the first sheet unidirectionally, a feeder configured to feed the second sheet obliquely toward the first sheet, a separation unit located downstream from the feeder in a direction in which the second sheet is transported, a reel, a contact portion located downstream from the separation unit in the direction in which the second sheet is transported, and a tensioner located upstream from the separation unit in the direction in which the second sheet is transported. The separation unit removes the release paper from the second sheet. The reel reels the release paper removed from the second sheet. The second sheet adheres to the first sheet via the adhesion layer 91b at the contact portion. The tensioner keeps the second sheet taut.

In another illustrative embodiment, an image forming apparatus includes at least one image carrier on which a toner image is formed, a transfer unit configured to transfer the toner image from the image carrier onto a first sheet, and the sheet bonding machine described above.

Yet in another illustrative embodiment, a sheet bonding method includes transporting a first sheet and a second sheet including an adhesion layer formed on one side thereof, covered with a release paper, obliquely to each other, removing the release paper from the second sheet at a separation position, keeping a portion of the second sheet located upstream from the separation position taut, and bonding together the first sheet and the second sheet at a predetermined bonding angle.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a schematic configuration of an image forming apparatus and a sheet bonding machine attached thereto, according to an illustrative embodiment of the present invention;

FIG. 2 schematically illustrates a cross-section of an image forming unit included in the image forming apparatus shown in FIG. 1;

FIG. 3 schematically illustrates a cross-section of the sheet bonding machine shown in FIG. 1;

FIG. 4 is a cross-sectional view illustrating a configuration of a main part of the sheet bonding machine shown in FIG. 3;

FIG. 5 is a cross-sectional view illustrating a configuration of a main part of a comparative sheet bonding machine;

FIG. 6 is a cross-sectional view illustrating bonding of a first sheet and a second sheet when a bonding angle is relatively small;

FIG. 7 is a cross-sectional view illustrating bonding of the first sheet and the second sheet when the bonding angle is relatively large;

FIG. 8 is a cross-sectional view illustrating light reflected on two sheets bonded together with air bubbles included therebetween;

FIG. 9 a cross-sectional view illustrating light reflected on two sheets bonded together without air bubbles;

FIG. 10 is a cross-sectional view illustrating a configuration of a main part of a sheet bonding machine according to another embodiment;

FIG. 11 illustrates a variation of the first sheet;

FIG. 12 illustrates another variation of the first sheet;

FIG. 13 illustrates another variation of the first sheet;

FIG. 14 is a plan view illustrating an original image according to illustrative embodiments; and

FIG. 15 is a plan view illustrating the first sheet on which a mirror image is formed according to the original image shown in FIG. 14.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

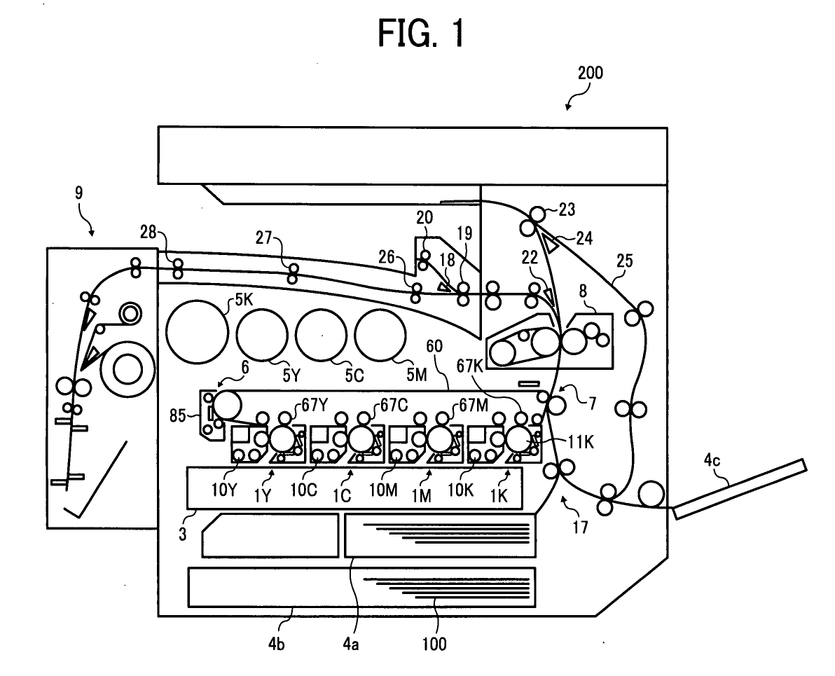

Referring now to the drawings, wherein like reference numerals designate identical or corresponding parts throughout the several views thereof, and particularly to FIGS. 1 through 3, a sheet bonding machine 9 and an electronographic image forming apparatus 200 according to an example embodiment of the present invention is described.

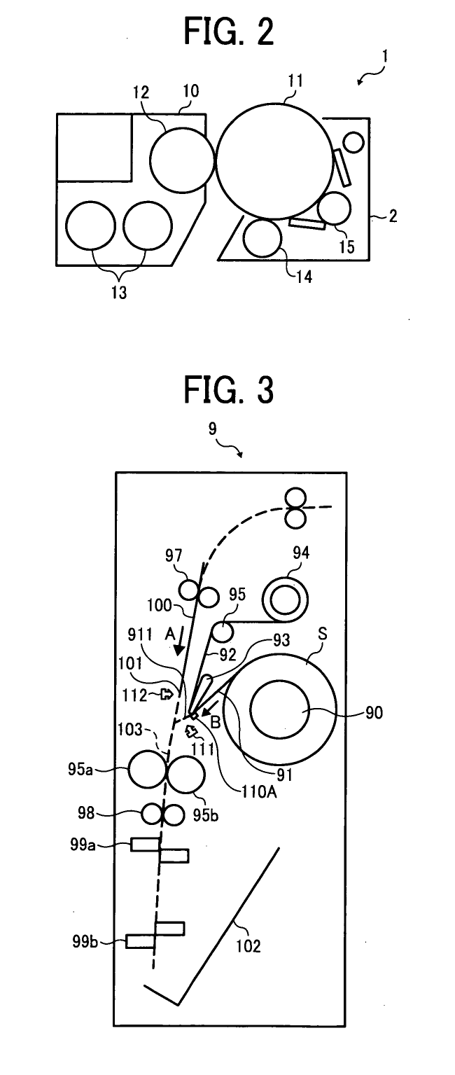

FIG. 1 illustrates a schematic configuration of the image forming apparatus 200 capable of full-color image formation, FIG. 2 illustrates a schematic configuration of a photoreceptor unit 1, and FIG. 3 illustrates the sheet bonding machine 9 that is externally attached to the image forming apparatus 200 as shown in FIG. 1.

The image forming apparatus 200 is described below with reference to FIG. 1.

As shown in FIG. 1, the image forming apparatus 200 includes image forming units 1Y, 1C, 1M, and 1K for forming yellow, cyan, magenta, and black images, respectively. It is to be noted that the image forming units 1Y, 1C, 1M, and 1K may be arranged differently from the arrangement sequence illustrated in FIG. 1.

The image forming units 1Y, 1C, 1M, and 1K include photoreceptor drums 11Y, 11C, 11M, and 11K serving as image carriers, and developing units 10Y, 10C, 10M, and 10K, respectively. The image forming units 1Y, 1C, 1M, and 1K are arranged so that rotary shafts of the photoreceptor drums 11Y, 11C, 11M, and 11K are aligned parallel to each other at a given interval in a direction in which a first sheet 100 travels. The developing units 10Y, 10C, 10M, and 10K use two-component developer including a carrier and a toner and have a similar configuration except for only the color of the toner used therein.

Beneath the image forming units 1Y, 1C, 1M, and 1K, an optical writing unit 3 is provided and includes a light source, a polygon mirror, an f-θ lens, reflection mirrors, etc., although not illustrated in FIG. 3. The optical writing unit 3 scans surfaces of the photoreceptor drums 11Y, 11C, 11M, and 11K according to image information with laser lights, forming electrostatic latent images thereon, respectively.

Above the image forming units 1Y, 1C, 1M, and 1K, a primary transfer unit 6 is provided. The primary transfer unit 6 includes a transfer transport belt 60 and primary transfer rollers 67Y, 67C, 67M, and 67K located to face the photoreceptor drums 11Y, 11C, 11M, and 11K via the transfer transport belt 60, respectively. The primary transfer rollers 67Y, 67C, 67M, and 67K transfer the yellow, cyan, magenta, and black images from the photoreceptor drums 11Y, 11C, 11M, and 11K, respectively, and these toner images are superimposed one on another onto the transfer transport belt 60, forming a full color toner image thereon.

A cleaner 85 including a brush roller and a cleaning blade is provided so as to contact an outer circumferential surface of the transfer transport belt 60. The cleaner 85 removes foreign materials, such as toner, adhered to the transfer transport belt 60.

Further, a secondary transfer unit 7 is provided on the right of the primary transfer unit 6, and a belt type fixer 8 is provided above the secondary transfer unit 7 in FIG. 1. The secondary transfer unit 7 transfers the toner image from the transfer transport belt 60 onto the first sheet 100.

The image forming apparatus 200 further includes a sheet cassettes 4a and 4b and a manual feed tray 4c. The sheet cassettes 4a and 4b are located in a bottom portion of the image forming apparatus 200 and contain the first sheets 100 that in the present embodiment are transparent recording media. A user can feed the first, sheet 100 manually from the manual feed tray 4c located on a side of the image forming apparatus 200.

The image forming apparatus 200 further includes toner containers 5Y, 5C, 5M, and 5K, a pair of registration rollers 17, separation claws 18, 22, and 24, transport rollers 19, 26, 27, and 28, a pair of discharge rollers 20, a discharge tray 21, a pair of reverse roller 23, and a reverse path 25. Further, although not shown in FIG. 1, the image forming apparatus 200 is further provided with a waste toner bottle, a power supply unit, and a controller including an operation panel. The controller controls the entire image forming apparatus 200 and the sheet bonding machine 9 via an interface.

It is to be noted that reference characters Y, M, C, and K show yellow, magenta, cyan, and black, respectively, and may be omitted in the description below when color discrimination is not necessary.

Referring to FIG. 2, the image forming unit 1 is further described below.

The image forming unit 1 further includes a charging roller 14 and a cleaner 15 located around the photoreceptor drum 11. The developing unit 10 includes a developing roller 12 facing the photoreceptor drum 11, screws 13 to agitate and transport the developer, and a toner concentration sensor, not shown. The developing roller 12 includes a rotary sleeve and magnets fixed therein, and carries the toner with the carrier on its rotary surface with magnetism of the magnets.

As described above, the electrostatic latent image corresponding to the color of the toner is formed on the photoreceptor drum 11 by the optical writing unit 3, and the developing roller 12 supplies the toner to the electrostatic latent image with electrical field effect, developing the electrostatic latent image into a toner image. The toner concentration sensor, not shown, detects a concentration of the toner in the developing unit 10, and a toner supplier, not shown, supplies the toner thereto according to an output from the toner concentration sensor.

It is to be noted that, in the present embodiment, the photoreceptor drum 11, the charging roller 14, and the cleaner 15 are integrated together as a photoreceptor unit 2 that is a cartridge removable from the image forming apparatus 200 to facilitate repair and replacement work.

Alternatively, the photoreceptor drum 11 and at least one of the developing unit 10, the charging roller 14, and the cleaner 15 are integrated together as a cartridge as required.

Formation of photographic image record sheets using the transparent first sheet 100 is described below with reference to FIGS. 1 and 2.

It is to be noted that, in the present embodiment, the optical writing unit 3 is set to a mirror image mode so as to form a mirror electrostatic latent image on the photoreceptor drum 11 when a photographic image mode using the first sheets 100 is selected.

First, the power supply unit, not shown, applies a predetermined or desirable voltage to the charging roller 14, and then the charging roller 14 uniformly charges the surface of the photoreceptor drum 11, facing the charging roller 14, to a predetermined or desirable electrical potential. Then, the optical writing unit 3 scans the surface of the photoreceptor drum 11 with a laser light according to image data, forming an electrostatic latent image thereon. When the electrostatic latent image on the surface of the photoreceptor drum 11Y reaches a position to face the developing roller 12, the developing roller 12 supplies toner thereto, forming a toner image thereon.

The processes described above are performed in each of the image forming units 1Y, 1C, 1M, and 1K at a predetermined or desirable timing, and thus yellow, cyan, magenta, and black images are formed on the surfaces of the photoreceptor drums 11Y, 11C, 11M, and 11K, respectively.

In order to form a photographic image record sheet, a mirror toner image is formed on the transparent first sheet 100. The first sheet 100 is transported from one of the sheet cassettes 4a and 4b and the manual feed tray 4c to the registration rollers 17, along with the image forming processes described above.

The primary transfer rollers 67 transfers the toner images from the photoreceptor drums 11Y, 11C, 11M, and 11K onto the transfer transport belt 60 sequentially. More specifically, the power source unit, not shown, applies a voltage having a polarity opposite the polarity of the toner images to each of the primary transfer rollers 67 facing the photoreceptor drums 11Y, 11C, 11M, and 11K via the transfer transport belt 60, respectively. While the transfer transport belt 60 moves rotatably and passes positions to face the photoreceptor drums 11Y, 11C, 11M, and 11K, the toner images are superimposed one on another thereon.

The secondary transfer unit 7 transfers the superimposed toner image from the transfer transport belt 60 onto the first sheet 100 sent by the registration rollers 17. The first sheet 100 is further transported to the fixer 8, where the toner image is fixed thereon with heat and pressure, passes the transport rollers 19, the separation claw 18, and then transported to the sheet bonding machine 9 by the transport rollers 26, 27, and 28.

It is to be noted that the image forming apparatus 200 can form images on typical recording media, such as transfer sheets as well as the transparent first sheet 100. When the typical recording medium is used, the optical writing unit 3 is set to a standard mode to form a normal image thereon, not a mirror image. When the standard mode is selected, after the fixer 8 fixes the image on the recording medium, the switch claw 18 switches a transport path of the recording medium so that the transport rollers 19 transports the recording medium to the discharge tray 21.

Further, the image forming apparatus 200 can form images on both side of the recording medium, in a double-side printing mode, in which the separation claw 22 switches the transport path of the recording medium to the reverse rollers 23 after a first image is fixed on a first side of the recording medium by the fixer 8. The reverse rollers 23 stop the recording medium and then forward the recording medium to the reverse path 25, and thus the recording medium is again transported to the registration rollers 17. The registration rollers 17 forward the recording medium to the secondary transfer unit 7, and then a second image is formed on its second side and fixed thereon by the fixer 8. Then, the recording medium is transported to the transport rollers 19.

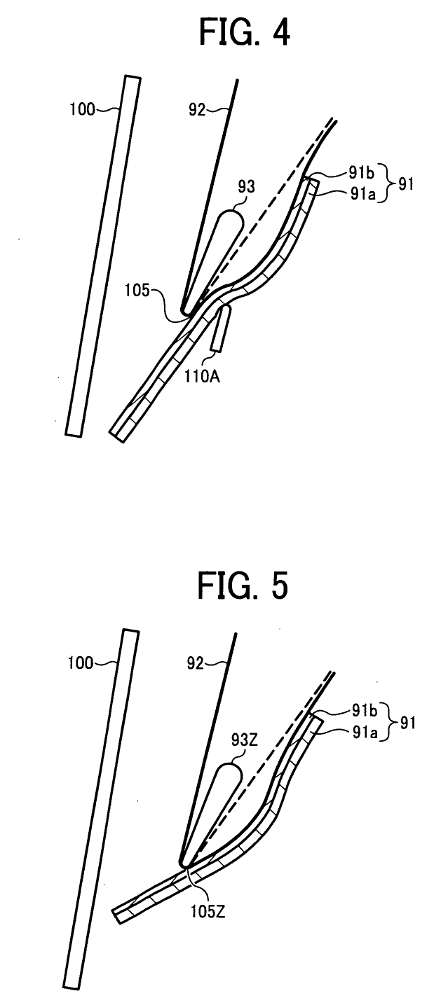

The sheet bonding machine 9 according to an illustrative embodiment of the present invention is described below with reference to FIGS. 3 and 4. FIG. 4 illustrates a main part of the sheet bonding machine 9.

As illustrated in FIG. 3, the sheet bonding machine 9 includes a support shaft 90 on which a rolled sheet S is set, a separation plate 93 serving as a separation unit, a reel shaft 94, and a roller 95. The sheet S includes a plurality of opaque second sheets 91 removably adhered to a continuous release paper 92 serving as a backing sheet thereof. The second sheet 91 is white paper sized for a given length in the present embodiment. The sheet S is rolled with the second sheets 91 inside.

The sheet bonding machine 9 further includes a pair of transport rollers 97 serving as a transport unit to unidirectionally transport the first sheet 100, which is transported from the image forming apparatus 200.

The rolled sheet S is set on the support shaft 90 so as to be unreeled by rotation of the support shaft 90. The separation plate 93 folds only the release paper 92 so as to remove the second sheet 91 therefrom through curvature separation at a separation point 105 shown in FIG. 4. The second sheets 91 are not folded back by the separation plate 93 together with the release paper 92 because their rigidity is higher than that of the release paper 92. Then, the release paper 92 is supported by the roller 95 and reeled by rotation of the reel shaft 94.

As shown in FIG. 3, when the release paper 92 is reeled by the reel shaft 94, a leading edge portion 911 of the second sheet 91 is transported in a direction indicated by arrow B, which is oblique to the direction indicated by arrow A, in which the first sheet 100 is transported. Also, the separation plate 93 supports the second sheet 91 to move oblique to the first sheet 100.

The present embodiment has a feature that the sheet bonding machine 9 includes the separation plate 93, a contact point 103, and a blade 110A serving as a tensioner. The separation plate 93 is located upstream from the adhesion point 103 in the direction in which the second sheet 91 moves, indicated by arrow B, and removes the release paper 92 from the second sheet 91 through curvature separation. The second sheet 91 is obliquely transported toward the first sheet 100 that is transported unidirectionally, and at the contact position 103, the second sheet 91 contacts the first sheet 100 and adheres thereto via the adhesion layer 91b. The blade 110A is located upstream from the separation plate 93 and tenses the second sheet 91.

As shown in FIG. 3, the sheet bonding machine 9 further includes pressure rollers 95a and 95b located downstream from the contact position 103 in a direction in which the first sheet 100 and the second sheet 91 bonded together is transported, a pair of transport rollers 98 located downstream from the pressure rollers 95a and 95b, cutters 99a and 99b, a tray 102, and sensors 111 and 112.

The sensor 111 is located upstream from the contact point 103 in the direction in which the second sheet 91 moves, indicated by arrow B, and detects the leading edge portion 911 of the second sheet 91. The sensor 112 is also located upstream from the contact point 103 in the direction in which the first sheet 100 moves, indicated by arrow A, and detects a leading edge portion 101 of the first sheet 100.

It is to be noted that the first sheet 100 and the second sheet 91 are transported at different speeds when the leading edge portion 911 of the second sheet 91 contacts the first sheet 100, that is, while bonding of these sheets is not completed, and these two sheets are transported at an identical or similar speed when bonding thereof is completed.

As shown in FIG. 4, the second sheet 91 includes an adhesion layer 91b formed on one side of a white base 91a, and a release layer of the release paper 92 and the adhesion layer 91b removably stick together. A mirror image is formed on one side of the first sheet 100 (image surface), and the first sheet 100 and the adhesion layer 91b of the second sheet are bonded together with the mirror image sandwiched therebetween so as to form a glossy photographic image record sheet.

FIG. 5 illustrates a main part of a comparative sheet bonding machine without a tensioner. Referring to FIGS. 3 through 5, bonding of the first sheet 100 and the second sheet 91 is further described below.

Referring to FIG. 3, when the reel shaft 94 reels the release paper 92, the support shaft 90 simultaneously rotates and feeds the second sheet 91. Even when the reel shaft 94 stops rotating, the support shaft 90 can continue to rotate up to a certain angle due to inertia.

As shown in FIG. 4, the blade 110A located upstream from the separation plate 93 keeps the second sheet 91 taut to prevent the second sheet 91 from slackening. By contrast, in the comparative sheet bonding machine shown in FIG. 5, the second sheet 91 can slacken upstream from a separation position 105Z.

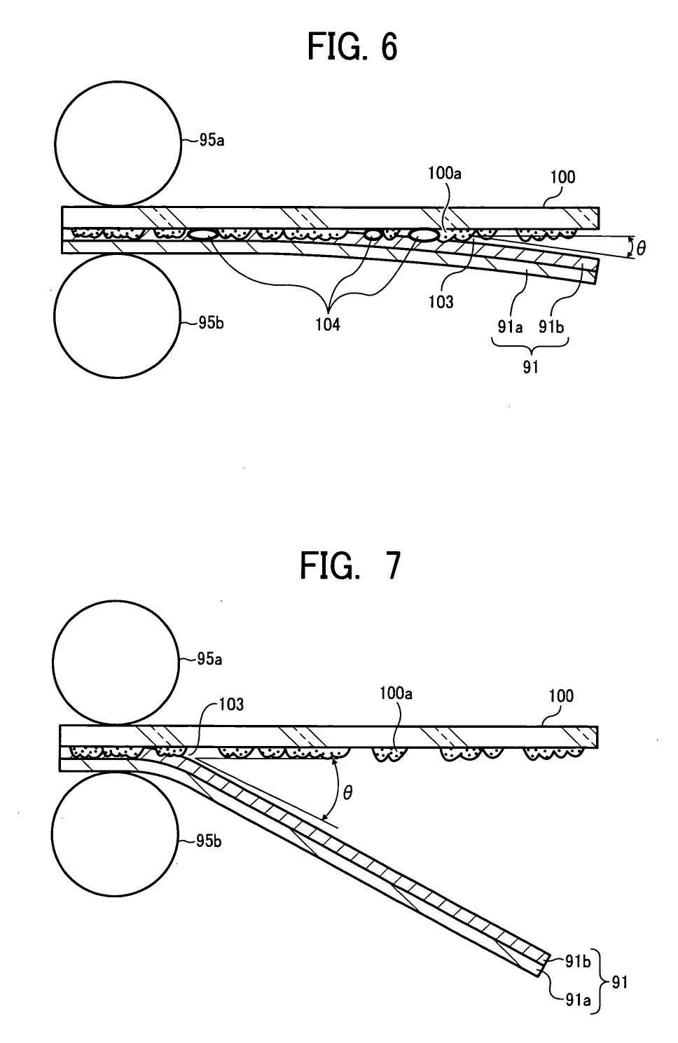

If the second sheet 91 slacks upstream from the separation position 105Z, a separation angle at which the second sheet 91 leaves the release paper 92 after passing a separation plate 93 fluctuates, which fluctuates bonding angle at which a first sheet 100 and the second sheet 91 are bonded together. If the bonding angle fluctuates, air bubbles are likely to enter the bonded sheet, as described below with reference to FIGS. 6 through 9.

FIGS. 6 and 7 illustrate relations between the bonding angle and air bubbles entering the bonded sheets. More specifically, FIG. 6 illustrates a case in which a bonding angle θ is relatively small, for example, less than 10 degrees, and FIG. 7 illustrates a case in which the bonding angle θ is relatively large, for example, greater than 30 degrees.

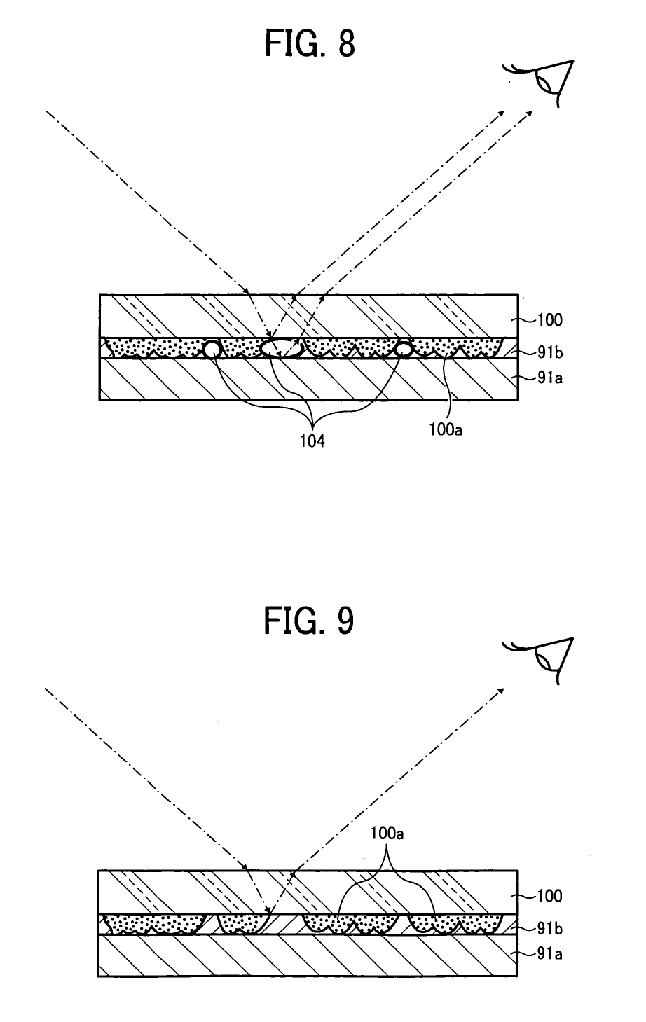

FIGS. 8 and 9 illustrate cross-sections of a bonded sheet including air bubbles 104 and a bonding sheet without air bubbles, respectively.

As shown in FIG. 6, when the bonding angle θ is relatively small, the contact position 103 is far from the pressure rollers 95a and 95b, and air bubbles 104 enter between the first sheet 100 and the adhesion layer 91b in portions where a mirror image 100a does not exist as shown in FIG. 6. These air bubbles 104 remain in the sheet that is fully bonded by the pressure rollers 95a and 95b. When the bonded sheet includes air bubbles 104, the air bubbles 104 diffuse reflection of light in the bonded sheet as shown in FIG. 8, giving the bonded sheet a turbid white that degrades image quality.

By contrast, as shown in FIG. 7, when the bonding angle θ is relatively large, the contact point 103 is closer to the pressure rollers 95a and 95b, preventing or reducing air bubbles 104 being included between the first sheet 100 and the adhesion layer 91b. As a result, the white base 91a is kept taut in portions where the mirror image 100a does not exist as shown in FIG. 9, and thus a glossy high quality image can be produced. It is to be noted that the bonding angle θ is preferably within a range of from about 30 degrees to 90 degrees.

Further, if the second sheet 91 slackens, the second sheet 91 might fail to adhere to a preferred portion of the first sheet 100, and air bubbles may more easily enter the bonded sheet. In such a case, when the pressure rollers 95a and 95b fully bond together these sheets with pressure, the second sheet 91 can wrinkle on the first sheet 100 or the bonded sheet can curl obliquely.

In view of the foregoing, in the present embodiment, the blade 110A tensions a portion of the second sheet 91 located upstream from the separation position 105 in order to reduce slackness of the second sheet 91 and maintain a preferred bonding angle θ. The blade 110A is elastic and presses against the second sheet 91 in a direction counter to the direction in which the second sheet 91 moves.

Thus, the blade 110A restricts slackness of the second sheet 91 to a portion upstream thereof, keeping the second sheet 91 free of slackness downstream thereof, and thus the separation angle at which the second sheet 91 leaves the release paper 92 is kept constant.

As described above with reference to FIGS. 3 and 4, the second sheet 91 is guided by the separation plate 93 and the blade 110A to move obliquely to the direction in which the first sheet 100 is transported by the transport rollers 97, and the leading edge portion 911 of the second sheet 91 contacts the leading edge portion 101 of the first sheet 100 at the contact position 103 at a predetermined or desirable angle.

Then, the adhesion layer 91b adheres to the first sheet 100, and a leading edge portion of these sheets temporarily bonded together is transported to the pressure rollers 95a and 95b, where the first sheet 100 and the second sheet 91 are fully bonded together. Because the blade 110A removes slackness from the second sheet 91 before the second sheet 91 contacts the first sheet 100, keeping the separation angle constant, the first sheet 100 and the second sheet 91 can be bonded together properly. Thus, the resultant image record sheet does not include air bubbles, and white portions where the mirror image 100a does not exist can be uniform as shown in FIG. 9.

The bonded sheet is further transported by the transport rollers 98 downward in FIG. 3, and a registration member, not shown, positions the leading edge portion of the bonded sheet. Then, the cutters 99a and 99b cut the bonded sheet to a predetermined or desired size, such as a standard photograph size. Examples of the cutters 99a and 99b include, but are not limited to, a slitter.

For example, the cutter 99a cuts off two parallel edge portions of the image record sheet, and then the image record sheet is rotated for 90 degrees and sent to the cutter 99b so that the cutter 99b cuts off the other two parallel edge portions of the image record sheet. Thus, the edge portions of the image record sheet in which the first sheet 100 and the second sheet 91 might not be aligned are removed. The image record sheet is then discharged onto the discharge tray 102. Alternatively, the image record sheet can be discharged from the sheet bonding machine 9.

Further, as described above, the sensors 111 and 112 shown in FIG. 3 detect the leading edge portion 911 of the second sheet 91 and the leading edge portion 101 of the first sheet 100, respectively, and thus transport error can be detected. Further, by detecting these edge portions and controlling the speed with which these sheets are transported, the first sheet 100 and the second sheet 91 can be transported so that the leading edge portion 911 and the leading edge portion 101 are aligned.

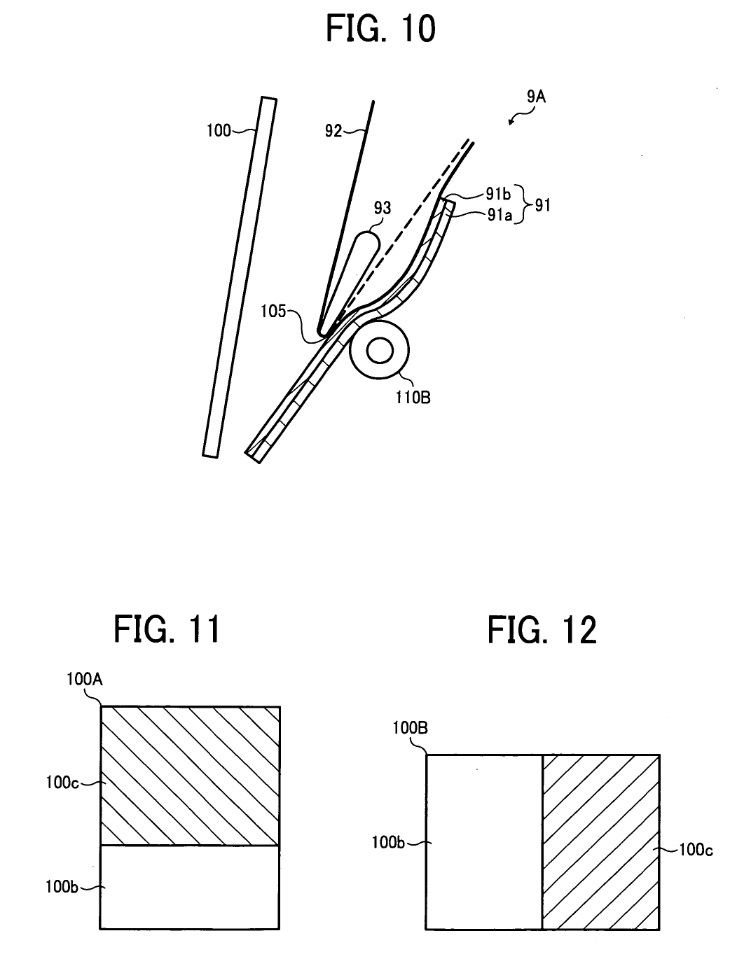

Another embodiment of the present invention is described below with reference to FIG. 10.

FIG. 10 illustrates a main part of a sheet bonding machine 9A. The sheet bonding machine 9A has a configuration similar to that of the sheet bonding machine 9 shown in FIGS. 3 and 4 and is used in conjunction with the image forming apparatus 200 shown in FIG. 1. However, a tensioner of the sheet bonding machine 9A is different from that of the sheet bonding machine 9 shown in FIGS. 3 and 4.

As shown in FIG. 10, the sheet bonding machine 9A includes a roller 110B as the tensioner located upstream from a separation position 105 where a release paper 92 leaves the second sheet 91 in a direction in which the second sheet moves. The roller 110B rotates with a load lower than a force to transport the second sheet 91 and is provided with a torque limiter to prevent the roller 110B from rotating under its own weight or inertia when transportation of the second sheet 91 is stopped. The roller 110B presses against the second sheet 91 from a side of the base 91a to make the second sheet 91 taut.

The roller 110B is configured so that frictional force between the roller 110B and the second sheet 91 is greater than a transportation force of the second sheet 91. As the second sheet 91 moves, the roller 110B does not prevent transportation of the second sheet 91 and rotates. Further, the roller 110B restricts slackness of the second sheet 91 to a portion upstream thereof, keeping the second sheet 91 free of slackness downstream thereof, similarly to the blade 110A of the sheet bonding machine 9 shown in FIG. 4. Thus, the separation angle with which the second sheet 91 leaves the release paper 92 is kept constant, and the second sheet 91 can adhere to a desired portion of the first sheet 100.

In the present embodiment, the roller 110B is a rubber roller and has a relatively high frictional coefficient in order not to slip on the second sheet 91, which can keep a contact pressure of the roller 110B against the second sheet 91 relatively low. An outer cylindrical surface of the roller 110B can be configured to extend to cover a full width of the second sheet 91. Alternatively, the roller 110B may partly press against properly divided portions of the second sheet 91.

It is to be noted that the material of the surface of the roller 110B is not limited to rubber, and thus may be any suitable substance.

Components of the sheet bonding machine 9A except the tensioner are identical or similar to those of the sheet bonding machine 9 shown in FIG. 3, and thus descriptions thereof are omitted.

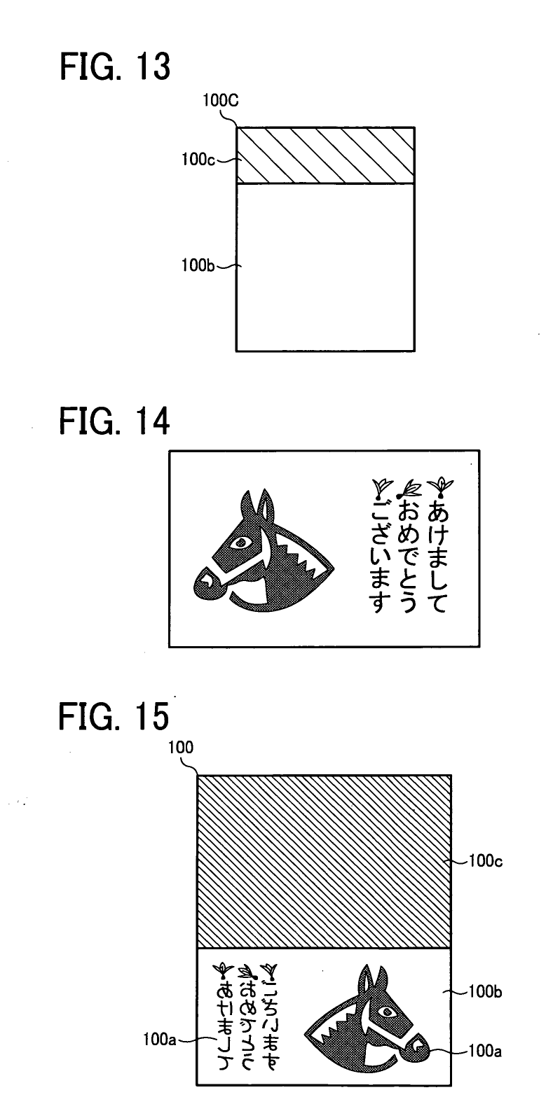

Further, it is to be noted that, although the first sheet 100 is entirely transparent in the embodiments described above, alternatively, the first sheet 100 may be partially transparent. FIGS. 11 through 14 respectively illustrate first sheets 100A, 100B, and 100C each including a partial transparent portion 100b and an opaque portion 100c.

When the partially transparent sheet is used, a mirror image 100a of an original image shown in FIG. 14 is formed in a transparent portion 100b as shown in FIG. 15, and the partially transparent sheet is covered with a white sheet having an adhesion layer.

It is to be noted that, although the second sheet 91 includes the white base 91a and the transparent adhesion layer 91b in the embodiments described above, alternatively, the second sheet 91 may include a transparent base and an opaque adhesion layer including, for example, a white colorant.

Further, the toner used in the embodiments described above is preferably a polymerized toner having a relatively small particle size, and the particle size is more preferable less than 6 μm. By using such a polymerized toner having a relatively small particle size, photographic image quality can be improved.

Further, the present invention may be applied to a sheet bonding method including transporting a first sheet and a second sheet covered with a release paper to contact each other, removing the release paper from the second sheet at a separation position, making a portion of the second sheet located upstream from the separation position taut, and bonding the sheets at a predetermined or desired bonding angle.

It is to be noted that, although the sheet bonding machine serves as a post-processing machine and is externally attached to the image forming apparatus in the embodiments described above, alternatively, the sheet bonding machine may be installed in the image forming apparatus.

Although the description above concerns a sheet bonding machine that functions in coordination with an image forming apparatus, the present invention may be applied to any device that bonds sheets, and is not limited to a device to output image record sheets.

Numerous additional modifications and variations are possible in light of the above teachings. It is therefore to be understood that, within the scope of the appended claims, the disclosure of this patent specification may be practiced otherwise than as specifically described herein.

What is claimed is:

1. A sheet bonding machine to bond together a first sheet and a second sheet including an adhesion layer formed on one side thereof, covered with a release paper,
the sheet bonding machine comprising:
a transport unit configured to transport the first sheet unidirectionally;
a feeder configured to feed the second sheet obliquely toward the first sheet;
a separation unit located downstream from the feeder in a direction in which the second sheet is transported, configured to remove the release paper from the second sheet;
a reel configured to reel the release paper removed from the second sheet;
a contact portion located downstream from the separation unit in the direction in which the second sheet is transported, at which the second sheet adheres to the first sheet via the adhesion layer 91b; and
a tensioner located upstream from the separation unit in the direction in which the second sheet is transported, configured to keep the second sheet taut.

2. The sheet bonding machine according to claim 1, wherein the tensioner is a blade pressing against the second sheet at a portion upstream from the separation unit in the direction in which the second sheet is transported.

3. The sheet bonding machine according to claim 2, wherein the tensioner presses against the second sheet in a direction counter to the direction in which the second sheet is transported.

4. The sheet bonding machine according to claim 3, wherein the tensioner comprises an elastic material.

5. The sheet bonding machine according to claim 1, wherein the tensioner is a roller pressing against the second sheet at a portion upstream from the separation unit in the direction in which the second sheet is transported, rotates as the second sheet moves, and is provided with a torque limiter to prevent the tensioner from rotating under its own weight or inertia when transportation of the second sheet is stopped.

6. The sheet bonding machine according to claim 5, wherein the tensioner comprises rubber.

7. The sheet bonding machine according to claim 1, wherein the separation unit separates the release paper from the second sheet through curvature separation.

8. The sheet bonding machine according to claim 1, wherein the first sheet includes a transparent portion on which an image is formed, the second sheet is opaque, and the first sheet and the second sheet are bonded together with the image sandwiched therebetween.

9. An image forming apparatus comprising:
at least one image carrier on which a toner image is formed;
a transfer unit configured to transfer the toner image from the image carrier onto a first sheet; and
a sheet bonding machine to bond the first sheet and a second sheet together, the sheet bonding machine including:
a transport unit configured to transport the first sheet unidirectionally,
a feeder configured to feed the second sheet obliquely toward the first sheet,
a separation unit located downstream from the feeder in a direction in which the second sheet is transported, configured to remove a release paper adhered to an adhesion layer formed on one side of the second sheet,
a reel configured to reel the release paper removed from the second sheet,
a contact portion located downstream from the separation unit in the direction in which the second sheet is transported, at which the second sheet adheres to the first sheet via the adhesion layer 91b, and
a tensioner located upstream from the separation unit in the direction in which the second sheet is transported, configured to keep the second sheet taut.

10. The image forming apparatus according to claim 9, wherein the toner image is formed with a polymerized toner of small particle size.

11. A sheet bonding method, comprising:
transporting a first sheet and a second sheet including an adhesion layer formed on one side thereof, covered with a release paper, obliquely to each other;
removing the release paper from the second sheet at a separation position;
keeping a portion of the second sheet located upstream from the separation position taut; and
bonding together the first sheet and the second sheet at a predetermined bonding angle.
